(19) United States
(12) Patent Application Publication
(10) Pub. No.: US 2025/0273247 A1
(43) Pub. Date: Aug. 28, 2025

(54) HARD DISK DRIVE DEVICE

(71) Applicant: MINEBEA MITSUMI Inc., Kitasaku-gun (JP)

(72) Inventor: Hideaki SHOWA, Kitasaku-gun (JP)

(21) Appl. No.: 19/059,513

(22) Filed: Feb. 21, 2025

(30) Foreign Application Priority Data
Feb. 26, 2024 (JP) 2024-026474

(51) Int. Cl. G11B 33/14

(52) U.S. Cl. CPC G11B 33/1466

(57) ABSTRACT

A hard disk drive device includes: a base plate including a bottom surface part and a side wall part extending in a direction orthogonal to the bottom surface part along an edge part of an entire periphery of the bottom surface part; a structure provided more inside than the side wall part and including a female screw part; a cover having a plate shape, fixed to the base plate such that a back surface faces the bottom surface part, and including a through hole at a position facing the structure; a screw inserted into the through hole and including a male screw part fitted with the female screw part; and a first sealing member disposed at least one of between the structure and the cover and between the cover and the fastening body, and formed in an annular shape.

### CROSS-REFERENCE TO RELATED APPLICATIONS

This application claims the benefit of priority to Japanese Patent Application Number 2024-026474 filed on Feb. 26, 2024. The entire contents of the above-identified application are hereby incorporated by reference.

### TECHNICAL FIELD

The disclosure relates to a hard disk drive device.

### BACKGROUND

A housing of the hard disk drive device includes a base plate and a cover. In the housing, a recording disk rotating at a high speed and a magnetic head floating by an airflow generated by rotation of the recording disk are disposed. A gap between the recording disk and the magnetic head is several nanometers to several tens of nanometers. Therefore, the cleanliness inside the housing needs to be kept high.

As a method of keeping the cleanliness inside the housing high, enhancement of the sealability of the housing is conceivable. For example, JP 2015-1990 A discloses a hard disk drive device having a gasket disposed between the base plate and the cover.

The cover is fastened to the base plate by a screw component with the gasket disposed between the cover and the base plate. Here, a fastening portion includes, other than an outer edge part of the base plate, a structure such as a shaft of a spindle motor and a pivot post disposed in a space inside the housing.

### SUMMARY

FIG. 11 is a cross-sectional view of a known hard disk drive device 201. A gasket 230 is disposed between a base plate 210 and a cover 220. On the other hand, as illustrated in FIG. 12, no gasket is disposed between the cover 220 fastened by a screw 240 and the fastening portion of a shaft 270 of a spindle motor. It is desired to apply such a structure for improving the sealability also to the fastening portion of the structure disposed in a space between the cover and the housing.

An object of the disclosure is to provide a hard disk drive device with a structure for improving sealability between a cover and a fastening portion of a structure disposed in a space inside a housing.

In order to solve the above problem, a hard disk drive device is provided, the hard disk drive device including: a base plate including a bottom surface part and a side wall part extending in a direction orthogonal to the bottom surface part along an edge part of an entire periphery of the bottom surface part; a structure provided more inside than the side wall part and including a female screw part; a cover having a plate shape, fixed to the base plate such that one surface faces the bottom surface part, and including a through hole at a position facing the structure; a fastening body inserted into the through hole and including a male screw part fitted with the female screw part; and a first sealing member disposed at least one of between the structure and the cover and between the cover and the fastening body, and formed in an annular shape.

According to the disclosure, it is possible to provide a hard disk drive device including a structure for improving sealability between a cover and a fastening portion of a structure disposed in a space inside a housing.

### BRIEF DESCRIPTION OF DRAWINGS

FIG. 1 is a perspective view of a hard disk drive device 1.

FIG. 2 is a cross-sectional view of the hard disk drive device 1.

FIG. 3 is a partial cross-sectional view of the cover 20.

FIG. 4 is a partial cross-sectional view of a spindle motor 3 of FIG. 2.

FIG. 5 is an enlarged view of a V part of FIG. 2.

FIG. 6 is an enlarged view of the V part of FIG. 2 in a modification.

FIG. 7 is an enlarged view of the V part of FIG. 2 in a modification.

FIG. 8 is an enlarged view of the V part of FIG. 2 in a modification.

FIG. 9 is an enlarged view of the V part of FIG. 2 in a modification.

FIG. 10 is an enlarged view of the V part of FIG. 2 in a modification.

FIG. 11 is a cross-sectional view of the known hard disk drive device 201.

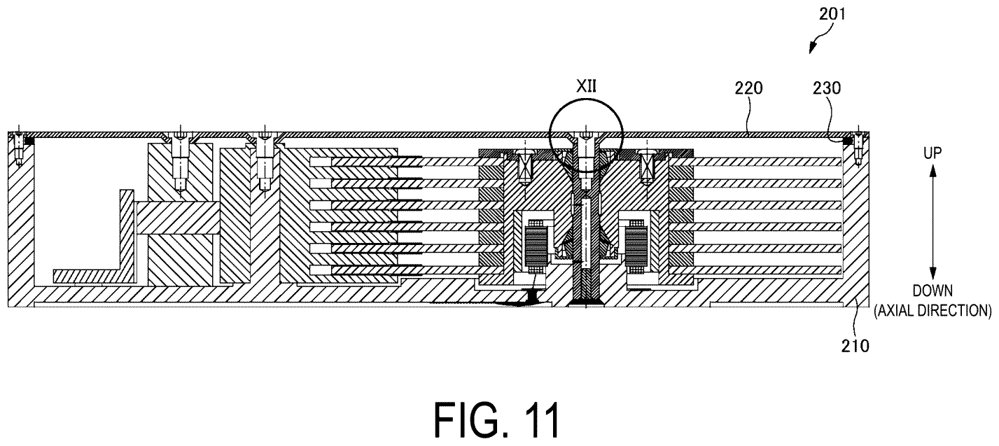

FIG. 12 is an enlarged view of a part XII of FIG. 11.

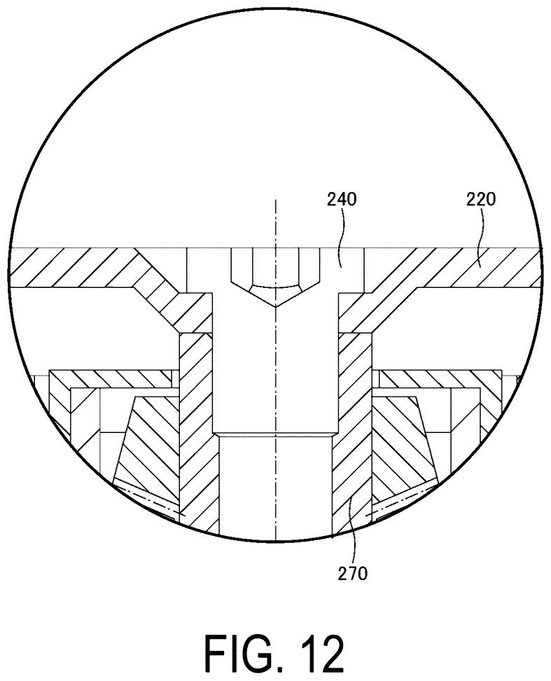

### DESCRIPTION OF EMBODIMENTS

Hereinafter, an embodiment of the disclosure will be described with reference to the drawings. However, while various technically preferable limitations for carrying out the disclosure are attached to the embodiment described below, the scope of the disclosure is not limited to the following embodiment and illustrated examples.

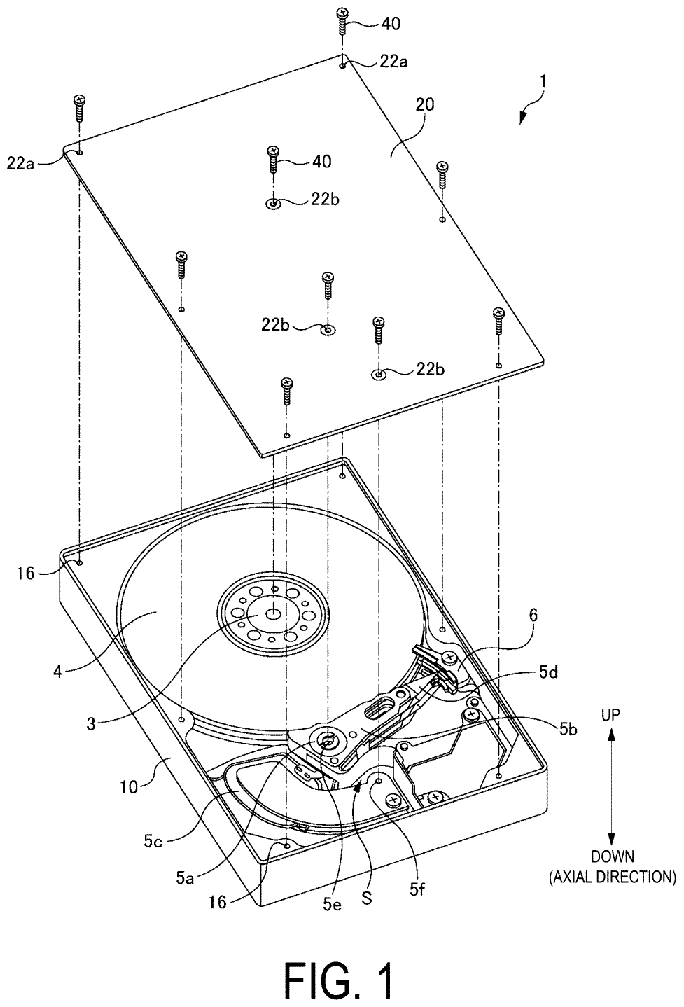

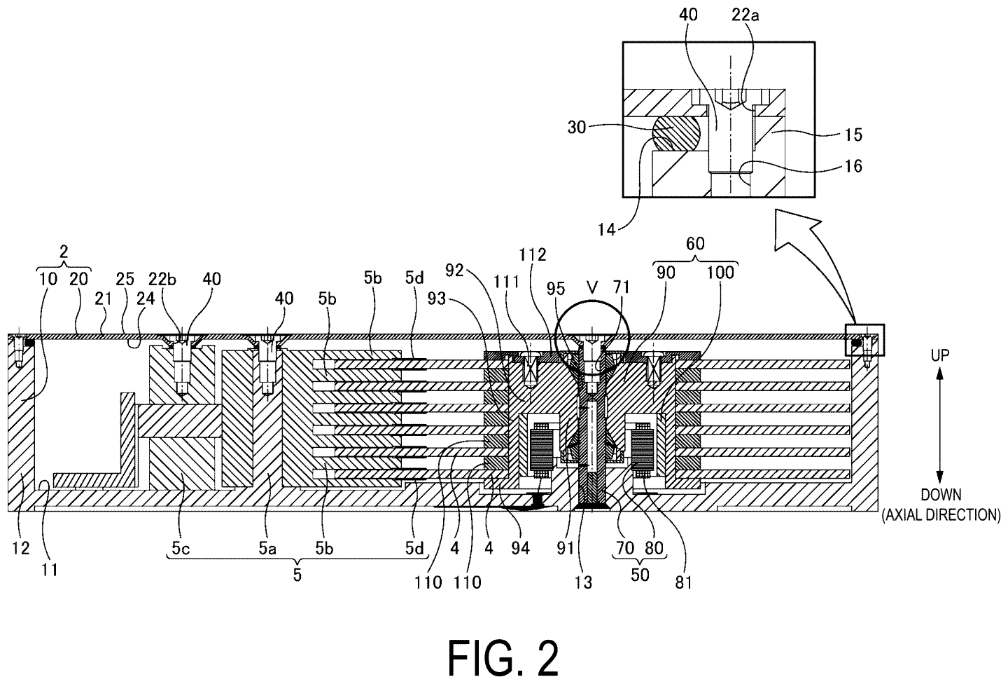

FIG. 1 is a perspective view illustrating the configuration of the hard disk drive device 1. FIG. 2 is a cross-sectional view of the hard disk drive device 1.

Here, as illustrated in FIG. 2 and the like, a direction parallel to a center axis of a shaft 70 described later is defined as an axial direction, a direction around the center axis of the shaft 70 is defined as a circumferential direction, and a direction perpendicular to the axial direction is defined as a radial direction. For the sake of description, the axial direction is defined as an up-down direction, where the cover 20 side is the up and a base plate 10 side is down.

### Hard Disk Drive Device

The hard disk drive device 1 includes a housing 2, the spindle motor 3, a recording disk 4, and a data reading/writing device 5.

The housing 2 is a box-shaped case accommodating the spindle motor 3 and the like. The housing 2 includes the base plate 10, the cover 20, a gasket 30, and a screw 40 having a male screw part. The base plate 10 has a bottomed box shape with one surface opened. The gasket 30 is provided between the base plate 10 and the cover 20. The gasket 30 is provided over the entire periphery of a side wall part 12 along the side wall part 12 of the base plate 10 described later. The cover 20 is fastened to the base plate 10 using the screw 40 being a fastening body. Due to this, the base plate 10 and the cover 20 form the housing 2 having an internal space S. Note that the gasket 30 may be another sealing means such as an adhesive.

The internal space S of the housing 2 is filled with air and other gases. The internal space S accommodates the spindle motor 3, the recording disk 4, and the data reading/writing device 5.

The spindle motor 3 rotatably supports a plurality of the recording disks 4. Note that a detailed structure of the spindle motor 3 will be described later.

The plurality of recording disks 4 are provided and supported by the spindle motor 3 such that respective disk surfaces face one another. Gaps are formed between the respective recording disks 4. In the present embodiment, six recording disks 4 are supported by the spindle motor 3. Note that for the sake of description, in a state of being supported by the spindle motor 3, an upper front surface of the recording disk 4 is referred to as a front surface, and a lower front surface is referred to as a back surface.

The data reading/writing device 5 records data into the recording disk 4 or reads data from the recording disk 4. The data reading/writing device 5 includes a pivot post 5a, a swing arm 5b, a voice coil motor 5c, and a magnetic head 5d.

The pivot post 5a swingably supports a plurality of the swing arms 5b. The pivot post 5a is a member extending in the up-down direction. The pivot post 5a has a female screw part 5e on the upper surface. In the present embodiment, the pivot post 5a is integrated with the base plate 10. Note that the pivot post 5a may be configured as a component separate from the base plate 10 and attached to the base plate 10.

The swing arm 5b is swingably supported by the pivot post 5a. The swing arm 5b is disposed in a gap between the recording disks 4 and on the uppermost surface and the lowermost surface of the recording disk 4. The number of swing arms 5b is larger by one than the number of recording disks 4. In the present embodiment, seven swing arms 5b are supported by the pivot post.

The voice coil motor 5c swings the swing arm 5b around the pivot post 5a as a rotation center. The voice coil motor 5c swings the swing arm 5b in parallel with the front surface of the recording disk 4. The voice coil motor 5c has a female screw part 5f on the upper surface of a magnet disposed on the uppermost surface.

The magnetic head 5d magnetizes the recording disk 4 and reads magnetism from the recording disk 4. The magnetic head 5d is provided at a tip end of the swing arm 5b. One magnetic head 5d is provided for each of the front surface and the back surface of the plurality of recording disks 4.

The magnetic head 5d is disposed in a ramp mechanism 6 provided at a position away from the recording disk 4. The ramp mechanism 6 is a portion forming a retraction position of the magnetic head 5d. When the voice coil motor 5c is activated and the swing arm 5b swings, the magnetic head 5d moves from the ramp mechanism 6 to above the front surface or below the back surface of the recording disk 4, or moves from above the recording disk 4 to the ramp mechanism 6.

When the spindle motor 3 rotates, the recording disk 4 also rotates. When the swing arm 5b swings in this state, the magnetic head 5d moves from the ramp mechanism 6 to above the front surface or below the back surface of the rotating recording disk 4. Then, the magnetic head 5d magnetizes the recording disk 4 and records data onto the recording disk 4. The magnetic head 5d reads magnetism from the recording disk 4 and reads data recorded on the recording disk 4. On the other hand, when the magnetic head 5d does not magnetize the recording disk 4 or the magnetic head 5d does not read magnetism from the recording disk 4, the swing arm 5b swings, and the magnetic head 5d moves to the ramp mechanism 6 from above the front surface or below the back surface of the rotating recording disk 4.

### Base Plate

The base plate 10 includes a bottom surface part 11, the side wall part 12, and the pivot post 5a.

The bottom surface part 11 corresponds to a bottom surface in the base plate 10 having a bottomed box shape with one surface opened. The bottom surface part 11 is a member having a rectangular plate shape. The bottom surface part 11 is provided with the side wall part 12, a through hole 13, and the pivot post 5a.

The side wall part 12 corresponds to a wall of a side wall in the base plate 10 having a bottomed box shape with one surface opened. The side wall part 12 extends in a direction orthogonal from the bottom surface part 11 along an outer edge part of the entire periphery of the bottom surface part 11. The side wall part 12 extends from the bottom surface part 11 by the same length uniformly and has a tip end surface 14 at a tip end.

The tip end surface 14 is a surface opposite to the side connected to the bottom surface part 11 of the side wall part 12. The tip end surface 14 is formed over the entire periphery of the side wall part 12. A protrusion part 15 and a female screw part 16 are formed on the tip end surface 14.

The protrusion part 15 is formed on the tip end surface 14 over the entire periphery of the side wall part 12. The protrusion part 15 is formed at an outer edge part of the tip end surface 14. The protrusion part 15 is formed in a direction (parallel to the extending direction of the side wall part 12) orthogonal to the bottom surface part 11.

The female screw part 16 is a portion having the screw 40 inserted. The female screw part 16 is formed toward the bottom surface part 11 in parallel with the extending direction of the side wall part 12 extending from the tip end surface 14. In the present embodiment, six female screw parts 16 are formed on the tip end surface 14.

The through hole 13 is a hole provided so as to extend through the bottom surface part 11. The shaft 70 of the spindle motor 3 is inserted into the through hole 13.

The pivot post 5a extends in a direction orthogonal from the bottom surface part 11. The height from the bottom surface part 11 of the pivot post 5a is lower than the height of the side wall part 12. The pivot post 5a is provided in a region more inside than the side wall part 12 of the bottom surface part 11. An upper end surface of the pivot post 5a is provided with the female screw part 5e.

### Cover

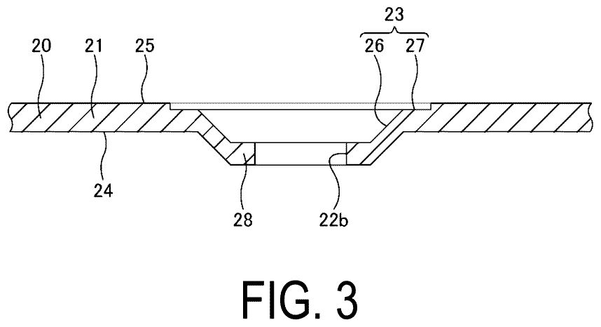

FIG. 3 is a partial cross-sectional view of the cover 20. The cover 20 is a member closing the opened surface of the base plate 10. The cover 20 includes a plate surface part 21, a through hole 22, and a recess part 23.

The plate surface part 21 is a member having a rectangular plate shape. The plate surface part 21 has a back surface 24 facing the bottom surface part 11 and a front surface 25 opposing to the back surface 24. Here, opposing means back to back, and the front surface 25 is a surface facing the back surface 24 in the plate surface part 21.

The through hole 22 is a hole extending through the plate surface part 21. In the present embodiment, six through holes 22 are provided near an outer edge of the plate surface part 21, and three are provided more inside than the outer edge of the plate surface part 21. Note that for the sake of description, the through hole 22 provided near the outer edge of the plate surface part 21 is referred to as a through hole 22a, and the through hole 22 provided more inside than the outer edge of the plate surface part 21 is referred to as a through hole 22b.

The through hole 22a is provided at a position facing the female screw part 16 in a state where the cover 20 is attached to the base plate 10.

The through hole 22b is provided at a position facing a structure provided more inside than the side wall part 12 of the base plate 10 in a state where the cover 20 is attached to the base plate 10. Here, the structure provided more inside than the side wall part 12 of the base plate 10 is the pivot post 5a, the voice coil motor 5c, and the spindle motor 3. The through hole 22b is provided at a position facing the female screw part 5e provided on the upper end surface of the pivot post 5a, the female screw part 5f provided on the upper end surface of the voice coil motor 5c, and a female screw part 71 provided on the upper end surface of the shaft 70 of the spindle motor 3 in a state where the cover 20 is attached to the base plate 10.

The recess part 23 is provided around the through hole 22b. The recess part 23 is a portion recessed from the front surface 25. The depth from the front surface 25 of the recess part 23 is larger than the thickness of the plate surface part 21. Therefore, the plate surface part 21 protrudes on the back surface 24 side at the portion provided with the recess part 23. In the present embodiment, three recess parts 23 are provided in the plate surface part 21. The recess part 23 has a first recess part 26 and a second recess part 27.

The first recess part 26 accommodates the screw 40 in a portion recessed from the front surface 25. The first recess part 26 is continuous in an up-down direction with the through hole 22b. The depth of the first recess part 26 is larger than an axial length of the head of the screw 40. The first recess part 26 is provided in a annular shape in axial view around the through hole 22b. The first recess part 26 has an inner diameter gradually decreasing from the front surface 25 side toward the back surface 24 side. The minimum inner diameter of the first recess part 26 is larger than the diameter of the through hole 22b and larger than the diameter of the head of the screw 40. A bottom surface part 28 coming into contact with the head of the screw 40 is formed at a lower end of the first recess part 26.

The second recess part 27 is provided continuously in the axial direction with the first recess part 26. The second recess part 27 is provided in a annular shape in axial view around the through hole 22b. The second recess part 27 has an outer diameter larger than the outer diameter of the first recess part 26 in axial view.

### Spindle Motor

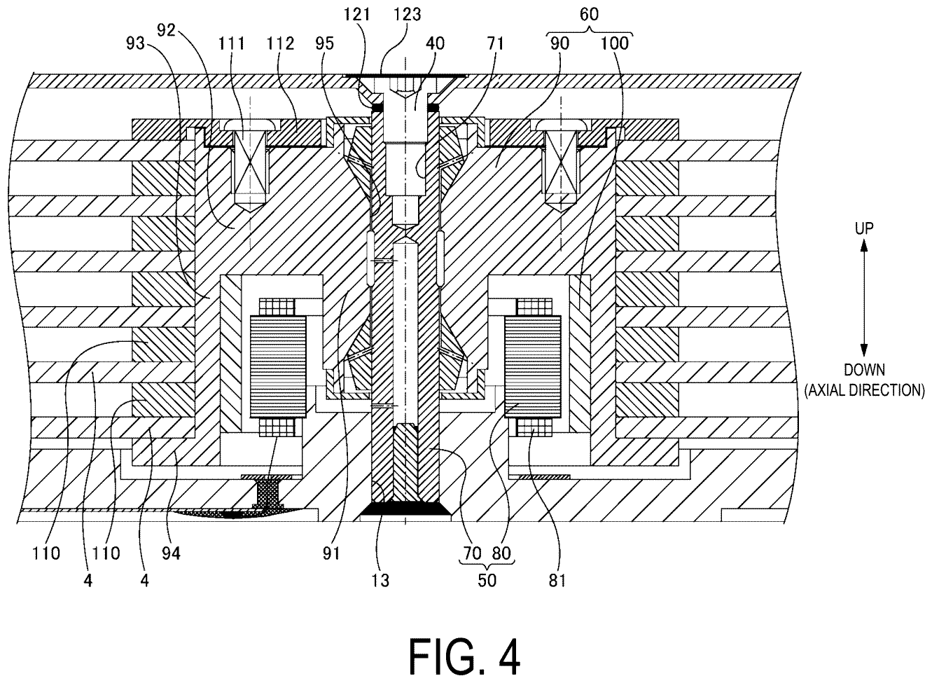

Next, a detailed configuration of the spindle motor 3 will be described. FIG. 4 is a partial cross-sectional view of the spindle motor 3. The spindle motor 3 includes a stationary part 50 and a rotation part 60 rotating with respect to the stationary part 50 via a bearing mechanism.

### Stationary Part

The stationary part 50 includes the shaft 70 and a stator core 80.

The shaft 70 is a metal member having a columnar rod shape. A portion partially including one end of the shaft 70 is inserted into the through hole 13 of the base plate 10 and fixed with an adhesive. The shaft 70 is provided with the female screw part 71 on the other end surface (upper end surface).

The stator core 80 is a member having a plurality of electromagnetic steel sheets having an annular shape in axial view stacked in the axial direction. The stator core 80 is disposed near the through hole 13 and is fixed to the base plate 10 by a method such as adhesion. The stator core 80 has a plurality of pole teeth (salient poles) extending radially outward and arranged along the circumferential direction. A coil 81 is wound around the pole teeth. The stator core 80 generates a magnetic flux when a current flows through the coil 81.

### Rotation Part

The rotation part 60 includes a rotor hub 90 and a rotor magnet 100.

The rotor hub 90 is a member rotating with respect to the shaft 70. The rotor hub 90 includes an inner cylindrical wall part 91, a disc part 92, an outer cylindrical wall part 93, and an outer edge part 94.

The inner cylindrical wall part 91 is a member having a substantially cylindrical shape. A rotor hub through hole 95 axially extending through the rotor hub 90 is formed at the center (a part corresponding to the rotation center of the rotor hub 90) of the inner cylindrical wall part 91. The shaft 70 is inserted into the rotor hub through hole 95.

The disc part 92 is a member having a disc shape coaxially with the center of the inner cylindrical wall part 91 in axial view. The disc part 92 is formed radially outward from the inner cylindrical wall part 91.

The outer cylindrical wall part 93 is a member having a cylindrical shape having a thickness in the radial direction. The outer cylindrical wall part 93 is provided coaxially with the center of the inner cylindrical wall part 91 in axial view, and protrudes axially downward. The outer cylindrical wall part 93 is provided at the outer edge of the disc part 92.

The outer edge part 94 is a member having an annular shape. The outer edge part 94 is provided at the lower end of the outer cylindrical wall part 93. The outer edge part 94 protrudes radially outward from the outer cylindrical wall part 93 and is formed in a flange shape. The plurality of recording disks 4 are installed above the outer edge part 94 and radially outside the outer cylindrical wall part 93.

The plurality of recording disks 4 are installed so as to be stacked in the axial direction. Between two recording disks 4 axially adjacent to each other, a spacer 110 is disposed and a gap is formed. That is, the recording disks 4 and the spacers 110 are alternately stacked in the axial direction. The plurality of recording disks 4 and the spacers 110 stacked in this manner are fixed to the rotor hub 90 by a clamp 112 attached to the upper surface of the rotor hub 90 with a screw part 111.

The rotor magnet 100 is a member having an annular shape having a magnetic pole structure magnetized in a state where the polarity is inverted to N, S, N, S . . . along the circumferential direction in axial view. The rotor magnet 100 is attached to the inner peripheral surface of the outer cylindrical wall part 93.

A minute gap is formed between the shaft 70 and the inner peripheral surface of the rotor hub through hole 95. Then, the minute gap is filled with lubricating oil. Furthermore, a dynamic pressure generation groove not illustrated is formed in at least one of the shaft 70 and the rotor hub 90. Due to this, a fluid dynamic bearing is formed.

### Operation of Spindle Motor

When the coil 81 is energized, the magnetic attraction force and the magnetic repulsive force generated between the magnetic pole of the rotor magnet 100 and the pole teeth of the stator core 80 are switched. As a result, the rotation part 60 rotates about the shaft 70.

As the rotor hub 90 of the rotation part 60 rotates at a high speed, the lubricating oil filled in the minute gap is pressurized by the dynamic pressure generation groove. As a result, dynamic pressure is generated in the fluid dynamic bearing. Due to the generated dynamic pressure, the rotor hub 90 rotates while being supported in a non-contact state with respect to the shaft 70.

### Sealing Member

In the present embodiment, the hard disk drive device 1 includes a first sealing member 121 and a third sealing member 123 in order to enhance the sealability of the internal space S.

The first sealing member 121 seals a gap of disposed portions. The first sealing member 121 is disposed at least one of between the structure and the cover 20 and between the cover 20 and the screw 40. The first sealing member 121 is formed in an annular shape. The first sealing member 121 surrounds the screw 40. In the present embodiment, the first sealing member 121 is a solid gasket formed in the annular shape. The first sealing member 121 is disposed between the upper end surface of the pivot post 5a and the cover 20, between the upper end surface of the voice coil motor 5c and the cover 20, and between the upper end surface of the shaft 70 and the cover 20. The first sealing member 121 is in contact with each of the upper end surface of the pivot post 5a and the back surface 24 of the cover 20, the upper end surface of the voice coil motor 5c and the back surface 24 of the cover 20, and the upper end surface of the shaft 70 and the back surface 24 of the cover 20.

The third sealing member 123 seals the first recess part 26 from the front surface 25 side. The third sealing member 123 is provided in the second recess part 27 so as to cover the first recess part 26. The third sealing member 123 has a circular shape in axial view. The outer diameter of the third sealing member 123 is larger than the maximum inner diameter of the first recess part 26. The material of the third sealing member 123 is resin or metal. The third sealing member 123 is fixed to the plate surface part 21 by applying an adhesive or a pressure-sensitive adhesive to the outer edge part of the surface disposed on the first recess part 26 side, or by welding the outer edge part to the plate surface part 21. In the present embodiment, the third sealing member 123 is a resin member having a circular shape in axial view. The third sealing member 123 is fixed to the plate surface part 21 by applying an adhesive to the outer edge part of the surface disposed on the first recess part 26 side.

Here, the first sealing member 121 is disposed at least one of between the structure provided more inside than the side wall part 12 of the base plate 10 and the cover 20 and between the cover 20 and the screw 40 inserted into the through hole 22b. The third sealing member 123 is provided in the second recess part 27 so as to cover the first recess part 26 continuous with the through hole 22b. That is, the first sealing member 121 and the third sealing member 123 are provided more inside than the gasket 30 provided over the entire periphery of the side wall part 12 along the side wall part 12 of the base plate 10.

### Modifications

Note that the hard disk drive device 1 may be a combination of the following changes.

### (1) Modification 1

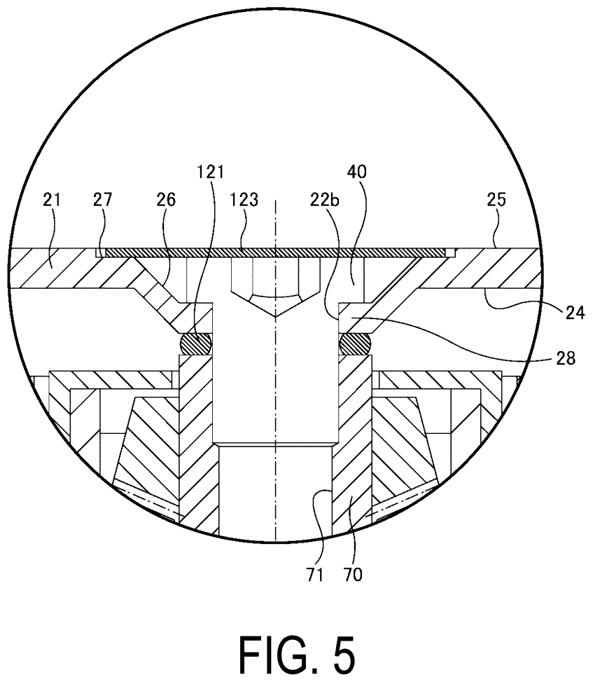

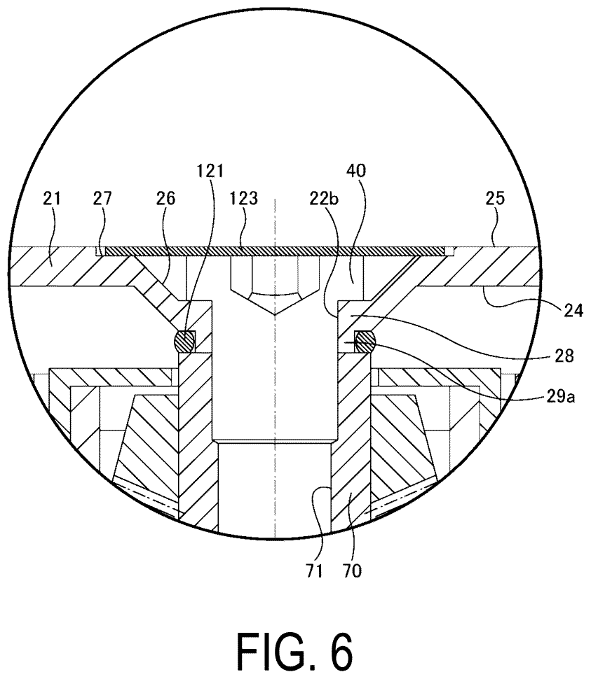

The first sealing member 121 may be provided at other than the positions illustrated in FIGS. 2 and 5. At this time, the shape of the cover 20 can be any shape. As illustrated in FIG. 6, for example, the cover 20 includes a protrusion part 29a formed so as to axially protrude from the lower surface of the bottom surface part 28. The protrusion part 29a is in contact with the upper end surface of the shaft 70. The outer diameter of the protrusion part 29a is smaller than the outer diameter of the shaft 70. At this time, a gap is formed between the lower surface of the bottom surface part 28 and the upper end surface of the shaft 70. The first sealing member 121 is disposed in the gap between the lower surface of the bottom surface part 28 and the upper end surface of the shaft 70.

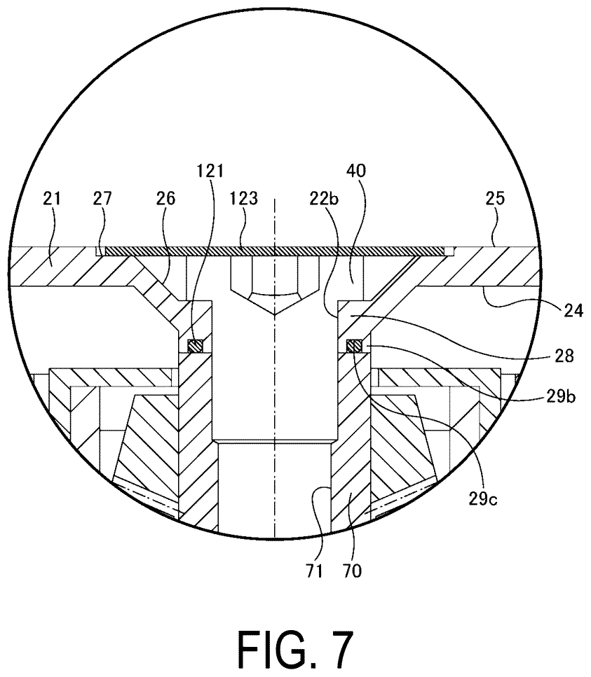

As illustrated in FIG. 7, for example, the cover 20 includes a protrusion part 29b formed so as to axially protrude from the lower surface of the bottom surface part 28, and a groove part 29c provided on the lower end surface of the protrusion part 29b. The protrusion part 29b is in contact with the upper end surface of the shaft 70. The outer diameter of the protrusion part 29b is equal to the outer diameter of the shaft 70. The lower end surface of the protrusion part 29b is provided with the groove part 29c formed so as to be recessed upward. The groove part 29c is provided in an annular shape on the lower end surface of the protrusion part 29b. The first sealing member 121 is disposed in the groove part 29c.

### (2) Modification 2

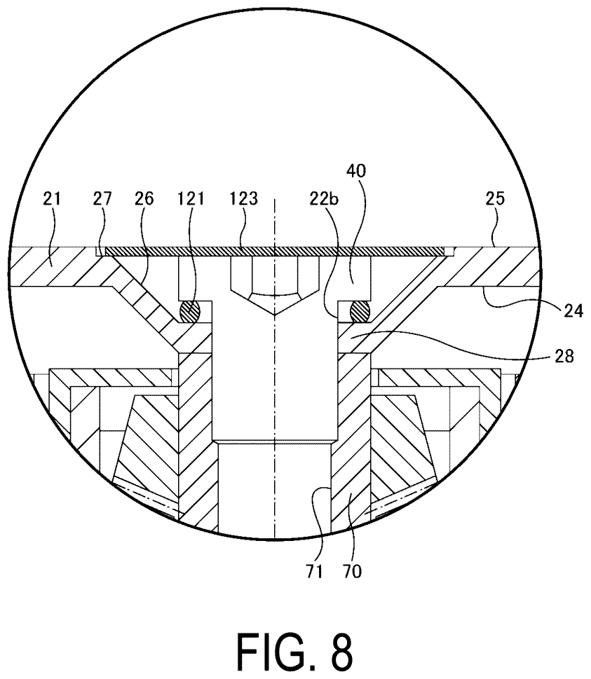

As illustrated in FIG. 8, the hard disk drive device 1 may have the first sealing member 121 disposed between the cover 20 and the screw 40.

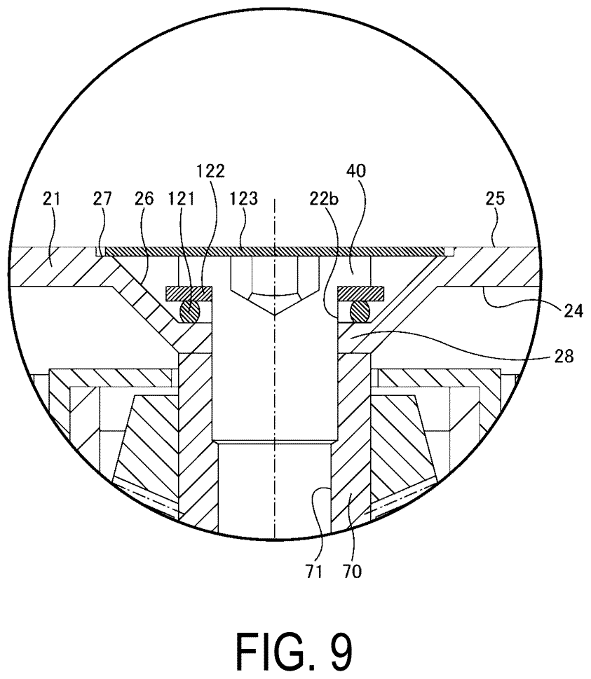

As illustrated in FIG. 9, a second sealing member 122 may be further disposed between the screw 40 and the first sealing member 121.

The second sealing member 122 reduces a force applied to the first sealing member 121 at the time of tightening the screw 40. The second sealing member 122 is a member having an annular shape in axial view. The second sealing member 122 surrounds the screw 40. The material of the second sealing member 122 is resin or metal. The second sealing member 122 is fixed to the upper side of the first sealing member 121 by applying an adhesive or a pressure-sensitive adhesive to a flat surface in contact with the first sealing member 121. Note that the second sealing member 122 is provided more inside than the gasket 30 provided over the entire periphery of the side wall part 12 along the side wall part 12 of the base plate 10.

### (3) Modification 3

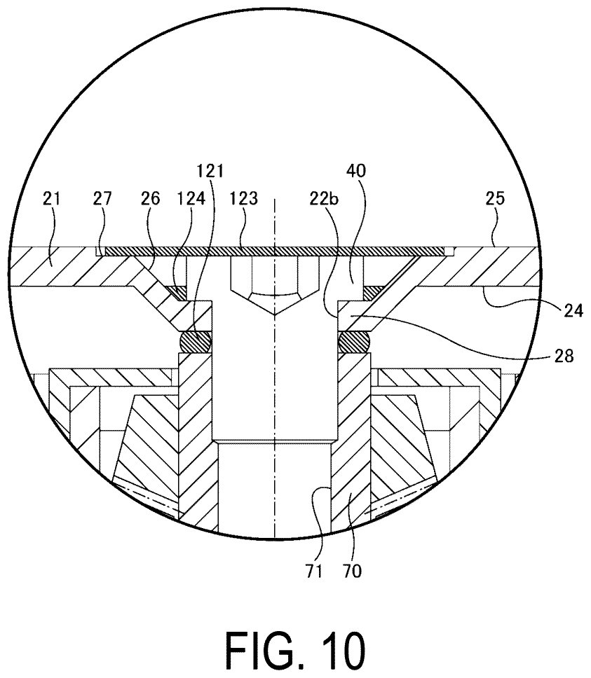

As illustrated in FIG. 10, in the hard disk drive device 1, the screw 40 may be applied with a fourth sealing member 124 in the first recess part 26 in a state where the screw 40 is inserted into the through hole 22b.

The fourth sealing member 124 seals a gap between the screw 40 and the bottom surface part 28. The fourth sealing member 124 is applied to the screw 40 in the first recess part 26. The fourth sealing member 124 is an adhesive or a liquid gasket. The fourth sealing member 124 is applied to the outer peripheral surface of the screw 40 after the screw 40 is fastened to the female screw part 5e, the female screw part 5f, and the female screw part 71. Note that the liquid gasket is a formed in place gasket (FIPG), a cured in place gasket (CIPG), or the like. The fourth sealing member 124 is provided more inside than the gasket 30 provided over the entire periphery of the side wall part 12 along the side wall part 12 of the base plate 10.

Note that in FIGS. 6 to 10, the portion illustrated in FIG. 5 (the spindle motor 3 described as a structure having a female screw part) is applied with each modification. In each of the above-described modifications, the structure having the female screw part is also applied to the portions of the pivot post 5a and the voice coil motor 5c. The structure having the female screw part is not limited to the spindle motor 3, the pivot post 5a, and the voice coil motor 5c, and may be another structure. Furthermore, the above-described configuration may also be applied to the portion of the through hole 22a of the cover 20 fastened to the female screw part 16 of the base plate 10 with the screw 40.

### Effects

(Aspect 1) The hard disk drive device 1 according to the present embodiment includes: the base plate 10 including the bottom surface part 11 and the side wall part 12 extending in the direction orthogonal to the bottom surface part 11 along the edge part of the entire periphery of the bottom surface part 11; the structure provided more inside than the side wall part 12 and including the female screw parts 5e, 5f, and 71; the cover 20 having a plate shape, fixed to the base plate 10 such that the back surface 24 faces the bottom surface part 11, and including the through hole 22b at a position facing the structure; the screw 40 inserted into the through hole 22b and including the male screw part fitted with the female screw parts 5e, 5f, and 71; and the first sealing member 121 disposed at least one of between the structure and the cover 20 and between the cover 20 and the screw 40, and formed in an annular shape.

In the hard disk drive device 1 described above, the gap between the structure and the cover 20 or the gap between the cover 20 and the screw 40 is sealed by the first sealing member 121. Therefore, air outside the housing 2 is less likely to flow into the internal space S through these gaps. That is, the sealability of the internal space S is improved. As described above, it is possible to provide a hard disk drive device including a structure for improving sealability between a cover and a fastening portion of a structure disposed in a space inside a housing.

(Aspect 2) In Aspect 1, the hard disk drive device 1 further includes the second sealing member 122 disposed between the screw 40 and the first sealing member 121.

Since the hard disk drive device 1 described above further includes the second sealing member 122, the gap between the cover 20 and the screw 40 is more easily sealed. Therefore, air outside the housing 2 is less likely to flow into the internal space S through the gap between the cover 20 and the screw 40. That is, the sealability of the internal space S is further improved.

When the screw 40 is fastened, the second sealing member 122 disposed between the screw 40 and the first sealing member 121 functions as a cushioning material. As a result, the first sealing member 121 is less likely to be applied with an external force when the screw 40 is fastened, and the first sealing member 121 is less likely to be displaced.

(Aspect 3) In Aspect 1 or 2, the first sealing member 121 is a liquid gasket.

In the hard disk drive device 1 described above, since the first sealing member 121 is the liquid gasket, the first sealing member 121 easily enters the gap between the structure and the cover 20 or the gap between the cover 20 and the screw 40. Therefore, air outside the housing 2 is less likely to flow into the internal space S through the gap between the structure and the cover 20 or the gap between the cover 20 and the screw 40. That is, the sealability of the internal space S is further improved.

(Aspect 4) In any of Aspects 1 to 3, in the hard disk drive device 1, the cover 20 further includes the front surface 25 opposing to the back surface 24 and the recess part 23 recessed from the front surface 25, the recess part 23 includes the first recess part 26 provided around the through hole 22b and accommodating the screw 40 in a portion recessed from the front surface 25, and the second recess part 27 provided continuously with the first recess part 26 and having an outer diameter larger than the outer diameter of the first recess part 26 in axial view of the through hole 22b, and the third sealing member 123 provided in the second recess part 27 so as to cover the first recess part 26 is further included.

In the hard disk drive device 1 described above, the through hole 22b is closed by the third sealing member 123 provided in the second recess part 27 so as to cover the first recess part 26. Therefore, the through hole 22b is doubly sealed by the first sealing member 121 and the third sealing member 123. Therefore, air outside the housing 2 is less likely to flow into the internal space S through the gap between the structure and the cover 20 or the gap between the cover 20 and the screw 40. That is, the sealability of the internal space S is further improved.

(Aspect 5) In any of Aspects 1 to 4, the hard disk drive device 1 further includes the fourth sealing member 124 applied to the screw 40 in the first recess part 26.

In the hard disk drive device 1 described above, the gap between the cover 20 and the screw 40 is easily sealed by the fourth sealing member 124. Therefore, air outside the housing 2 is less likely to flow into the internal space S through the gap between the cover 20 and the screw 40. That is, the sealability of the internal space S is further improved.

(Aspect 6) In Aspect 5, in the hard disk drive device 1, the fourth sealing member 124 is a liquid gasket.

In the hard disk drive device 1 described above, since the fourth sealing member 124 is a liquid gasket, the fourth sealing member 124 easily enters the gap between the cover 20 and the screw 40. As a result, the gap between the cover 20 and the screw 40 is easily sealed by the fourth sealing member 124. Therefore, air outside the housing 2 is less likely to flow into the internal space S through the gap between the cover 20 and the screw 40. That is, the sealability of the internal space S is further improved.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A hard disk drive device comprising:
a base plate including a bottom surface part and a side wall part extending in a direction orthogonal to the bottom surface part along an edge part of an entire periphery of the bottom surface part;
a structure provided more inside than the side wall part and including a female screw part;
a cover having a plate shape, fixed to the base plate such that one surface faces the bottom surface part, and including a through hole at a position facing the structure;
a fastening body inserted into the through hole and including a male screw part fitted with the female screw part; and
a first sealing member disposed at least one of between the structure and the cover and between the cover and the fastening body, and formed in an annular shape.

2. The hard disk drive device according to claim 1, further comprising:
a gasket provided between the base plate and the cover and over the entire periphery of the side wall part along the side wall part.

3. The hard disk drive device according to claim 1, further comprising:
a second sealing member disposed between the fastening body and the first sealing member.

4. The hard disk drive device according to claim 1,
wherein the first sealing member is a liquid gasket.

5. The hard disk drive device according to claim 1,
wherein the cover further includes an other surface opposing to the one surface and a recess part recessed from the other surface,
the recess part includes a first recess part provided around the through hole and accommodating the fastening body in a portion recessed from the other surface, and a second recess part provided continuously with the first recess part and having an outer diameter larger than an outer diameter of the first recess part in axial view of the through hole, and
a third sealing member provided in the second recess part so as to cover the first recess part is further included.

6. The hard disk drive device according to claim 5, further comprising:
a fourth sealing member applied to the fastening body in the first recess part.

7. The hard disk drive device according to claim 6,
wherein the fourth sealing member is a liquid gasket.
